(19) United States
(12) Patent Application Publication
(10) Pub. No.: US 2015/0378292 A1
(43) Pub. Date: Dec. 31, 2015

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Hiroshi Katakura, Numazu-shi (JP)

(21) Appl. No.: 14/319,482

(22) Filed: Jun. 30, 2014

(51) Int. Cl. G03G 15/01

(52) U.S. Cl. CPC G03G 15/50; G03G 15/01

(57) ABSTRACT

In accordance with one embodiment of the present invention, an image forming apparatus comprises: a first image forming section configured to form an image on a image receiving member with a first decolorable recording material the color of which can be thermally decolored; and a second image forming section configured at the downstream side in the advancement direction of the image receiving member than the first image forming section to form an image on the image receiving member with a second decolorable recording material higher than the first decolorable recording material in decoloring temperature.

### FIELD

Embodiments described herein relate generally to an image forming apparatus using decolorable toner.

### BACKGROUND

For the sake of protecting forest resources and reducing the emission of carbon dioxide, a technology has been put into practice in which a paper is reused by decoloring the color of the image formed on the paper with a recording material the color of which can be decolored by means of an applied external energy such as heat. However, according to this technology, colors of images are all decolored at a specific temperature as the decoloring temperature of a recording material is fixed, making it impossible to decolor colors of images selectively.

With respect to this, a technology is known according to which images (characters) are synchronously formed (printed) with a decolorable recording material and a non-dicolorable recording material so as to limit the content to be decolored. This technology is limited in use as the content printed with a non-dicolorable recording material cannot be decolored later.

Accordingly, a technology is proposed according to which a plurality of recording materials different in decoloring temperature are used in printing so that the printed content can be partially or wholly decolored selectively with different plural temperature settings.

However, in the image forming apparatus using such a technology, there is a problem that decoloring processing is insufficient and the image is still visible after the decoloring processing. This is caused as a plurality of recording materials which have different decoloring temperature are mixed during an image transfer process accompanied with a reverse transfer. The problem gets prominent in an cleaner-less type image forming apparatus.

### BRIEF DESCRIPTION OF THE DRAWINGS

FIG. 1 is a diagram exemplifying the configuration of an image forming apparatus involved in the embodiment; and

FIG. 2 is a diagram exemplifying the configuration of a decoloring apparatus involved in the embodiment.

### DETAILED DESCRIPTION

According to an embodiment of the present invention, a first image forming section configured to form an image on a image receiving member with a first decolorable recording material, the color of which can be thermally decolored and a second image forming section provided at the downstream of the first image forming section along an advancement direction of the image receiving member and configured to form an image on the image receiving member with a second decolorable recording material, a decoloring temperature of the second decolorable recording material being higher than the decoloring temperature of the first decolorable recording material.

According to an embodiment of the present invention, an image forming apparatus comprises a plurality of image forming sections provided with an image carrier and a developing device for developing the electrostatic latent image formed on the image carrier with a decolorable toner with which color can be decolored by heating, wherein the decolorable toners accommodated in the developing device are different in decoloring temperature; and a transfer section configured to transfer the toner images formed in the plurality of image forming sections to a image receiving member, wherein the plurality of image forming sections are arranged along the advancement direction of the image receiving member according to decoloring temperatures, from the highest to the lowest, of the accommodated decolorable toners.

Embodiments of the present invention are described below in detail with reference to the accompanying drawings.

In this embodiment, ‘decoloring’ means to make it difficult to recognize a color of an image formed on an image receiving member after the image is formed on the image receiving member by an recording material which has different color from the color of the image receiving material. The color of recording material may be achromatic color including black or white, not limiting to chromatic color. And in the following embodiment, ‘decoloring the image’ means ‘erasing the image’.

(Image Forming Apparatus)

First, the image forming apparatus provided in the embodiment is described. As an example, the image forming apparatus described in the embodiment is an MFP (Multi Function Peripheral) having a Print function, a Copy function of scanning and printing an original document or a Scan function and the like.

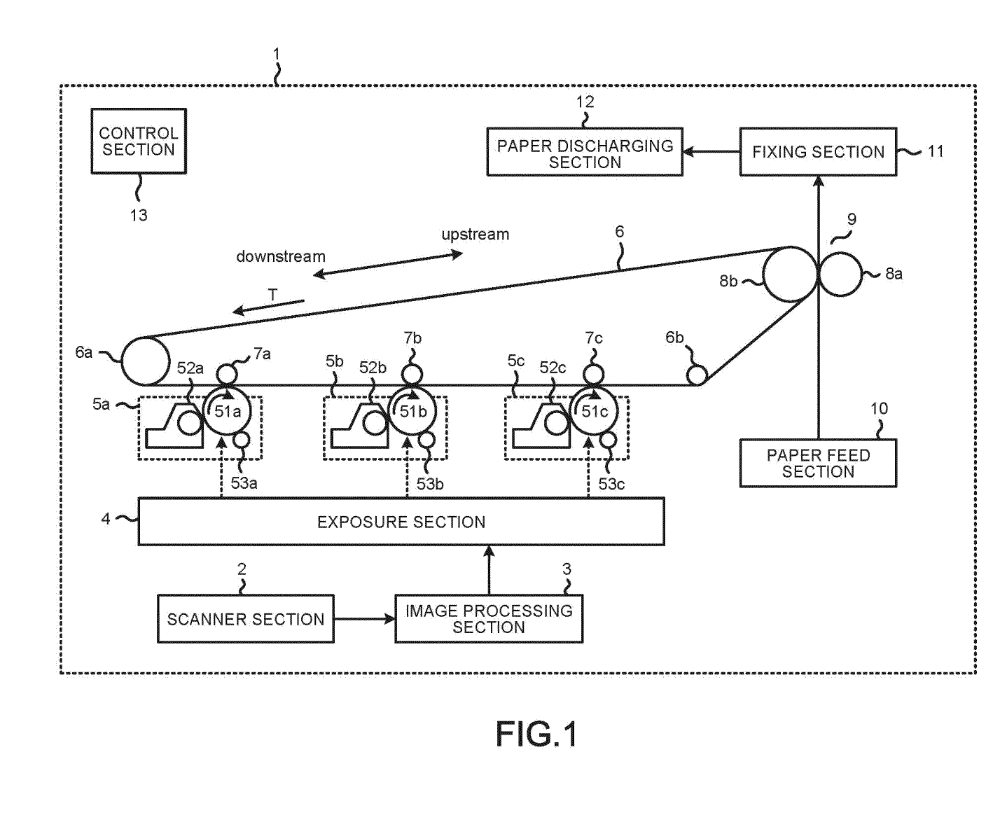

FIG. 1 is a diagram exemplifying an image forming apparatus 1 according to the embodiment. As shown in FIG. 1, the image forming apparatus 1 comprises: a scanner section 2, an image processing section 3, an exposure section 4, a first, a second and a third image forming sections 5a, 5b and 5c, an intermediate transfer belt 6, a primary transfer roller 7, a transfer section 9 provided with a secondary transfer roller 8a and a secondary transfer opposite roller 8b, a paper feed section 10, a fixing section 11 and a paper discharging section 12. The image forming apparatus 1 comprises a control section 13 for controlling the whole processing operations of the image forming apparatus 1. In the scanner section 2, an original document is read and image data is sent to the image processing section 3. In the image processing section 3, various image processing is carried out and a signal indicating the implementation of an image processing is output to the exposure section 4.

The first, the second and the third image forming sections 5a, 5b and 5c are successively arranged facing to the surface of the intermediate transfer belt 6 along the advancement direction (indicated by the arrow T shown in FIG. 1) of the intermediate transfer belt 6 as transferred bodies. Here, the intermediate transfer belt 6 takes an endless (seamless) shape and is wound on the secondary transfer opposite roller (drive roller) 8b and a driven roller 6a for rotating the intermediate transfer belt 6 at a given speed and a tension roller 6b applying a tension to the belt. The intermediate transfer belt 6 runs endlessly (along the direction indicated by the arrow T shown in FIG. 1) as the secondary transfer opposite roller 8b rotates so as to drive the driven roller 6a to rotate.

As separate image carriers, the first, the second and the third image forming sections 5a, 5b and 5c comprise photoconductive drums 51a, 51b and 51c, developing devices 52a, 52b and 52c and chargers 53a, 53b and 53c, respectively. The photoconductive drums 51a, 51b and 51c are respectively arranged opposite to primary transfer rollers 7a, 7b and 7c across the intermediate transfer belt 6. The first, the second and the third image forming sections 5a, 5b and 5c can be separately attached to or detached from the image forming apparatus 1.

The first, the second and the third image forming sections 5a, 5b and 5c correspond to a decolorable toner A (hereinafter referred to as ‘decolorable toner A’) serving as a first decolorable recording material having a decoloring function, a decolorable toner B (hereinafter referred to as ‘decolorable toner B’) serving as a second decolorable recording material higher than the decolorable toner A in decoloring temperature and a non-dicolorable toner C (hereinafter referred to as ‘non-dicolorable toner C’) serving as a non-dicolorable or inerasable recording material having no decoloring function, respectively. The decolorable toner A is accommodated in the developing device 52a, the decolorable toner B is accommodated in the developing device 52b, and the non-dicolorable toner C is accommodated in the developing device 52c.

Surfaces of the photoconductive drums 51a, 51b and 51c are charged to a given potential by the chargers 53a, 53b and 53c so as to form electrostatic latent images with, for example, the laser light and the like radiated from the exposure section 4 based on an image signal generated by the image processing section 3. The electrostatic latent images are developed by the decolorable toner A, the decolorable toner B and the non-dicolorable toner C fed from corresponding developing devices 52a, 52b and 52c to form developed images (toner images) on the surfaces of the photoconductive drums 51a, 51b and 51c in response to colors of the decolorable toner A, the decolorable toner B and the non-dicolorable toner C.

The developed images (toner images) formed on the photoconductive drums 51a, 51b and 51c are primarily transferred on the surface of the intermediate transfer belt 6 in the following order: the decolorable toner A, the decolorable toner B and the non-dicolorable toner C. A desired toner image is formed on the intermediate transfer belt 6 at the point of time the photoconductive drum 51c is passed.

After the transfer, the toners left on the photoconductive drums 51a, 51b and 51c but not transferred onto the surface of the intermediate transfer belt 6 are charged by the chargers 53a, 53b and 53c and collected by the developing devices 52a, 52b and 52c, respectively. Further, the toner transferred on the intermediate transfer belt 6 by the image forming section at the upstream side in the advancement direction of the intermediate transfer belt 6 and reversely transferred on the photoconductive drum of the image forming section at the downstream side in the advancement direction of the intermediate transfer belt 6 is collected by the developing device corresponding to the photoconductive drum on which the reverse transfer is conducted. For example, the decolorable toner A transferred on the intermediate transfer belt 6 by the first image forming section 5a is reversely transferred onto the photoconductive drum 51b of the second image forming section 5b at the downstream side in the advancement direction of the intermediate transfer belt 6. The reversely transferred decolorable toner A is charged by the charger 52b and collected by the developing device 53b.

The toner images transferred on the intermediate transfer belt 6 are batch (secondarily) transferred onto the recording paper (sheet) fed from the paper feed section 10 by the transfer section 9 consisting of a secondary transfer roller 8a and a secondary transfer opposite roller 8b arranged at the downstream side of the third image forming section 5c. The transfer of the developed images (toner images) is realized by generating an electric field between the secondary transfer opposite roller 8b and the secondary transfer roller 8a through a bias applied to the secondary transfer opposite roller 8b. Here, the same effect can be achieved by applying a bias having a reverse polarity to the secondary transfer roller 8a. The developed images (toner images) transferred onto the recording paper are fixed on the recording paper in the fixing section 11 with heat and pressure and discharged to the outside from the paper discharging section 12.

In this embodiment, the second image forming section in which the decolorable toner B higher in decoloring temperature than the decolorable toner A is stored may be arranged at the downstream side in the advancement direction of the intermediate transfer belt 6 of the first image forming section in which the decolorable toner A is stored. Further, the image forming sections are not limited to the three shown image forming sections. For example, in the absence of the non-dicolorable toner C, the first and the second image forming sections may be arranged. Further, a plurality of image forming sections may be arranged at the upstream side in the advancement direction of the intermediate transfer belt 6 of the second image forming section in which the decolorable toner B is stored, toners different in color from but identical in decoloring temperature to the decolorable toner A are stored in the plurality of image forming sections. Further, an image forming section in which a decolorable toner higher in decoloring temperature than the decolorable toner B is stored may be arranged at the downstream side in the advancement direction of the intermediate transfer belt 6 of the second image forming section in which the decolorable toner B is stored. In other words, toners decreased in decoloring temperature are successively arranged at the upstream side in the advancement direction of the intermediate transfer belt 6 serving as a image receiving member. Further, it is set in FIG. 1 that the transfer mode is an intermediate transfer mode in which images are transferred from an image carrier through the intermediate transfer belt 6; however, the transfer mode may also be a direct transfer mode in which images are directly transferred from an image carrier, without passing an intermediate transferred body. The image receiving member is recording paper (sheet) in the direct transfer mode. Further, the image forming apparatus may also be of a rotary type, but not limited to the shown tandem type.

Further, the image forming apparatus 1 disclosed herein is capable of selecting a toner for printing from an operation section when image data is sent from a printer, for example, in the use of a single toner, the image forming apparatus 1 is capable of separating needless image forming section and the intermediate transfer belt 6 with a separator mechanism (not shown) and stop driving needless image forming sections. Further, for example, if it is preset that black is the non-dicolorable toner C, blue is the decolorable toner B and other colors are the decolorable toner A, then the image acquired from a printer or the image acquired using the scanner section 2 can be determined using the image processing section 3, and a printing job is carried out after the determined image is exposed towards the image forming sections corresponding to the setting in the exposure section 4.

(Image Forming Method)

Next, the image forming method of the image forming apparatus 1 described above is described. As stated above, decoloring temperatures of the dicolorable toners A and B in the image forming apparatus 1 are different. Thus, for example, the character string or image desired not to be decolored is formed with the decolorable toner B higher in decoloring temperature, and that desired to be decolored or can be decolored is formed with the decolorable toner A lower in decoloring temperature. Further, for example, a pattern part, for example, a frame, in which character strings of a document are printed may be printed with the decolorable toner A lower in decoloring temperature, and character string entities of the document are printed with the decolorable toner B higher in decoloring temperature. Further, the character string or image desired not to be decolored may also be formed with the non-dicolorable toner C.

Which decolorable toner is used to form which part of an image can be designated at a text creating client terminal side by endowing a piece of text creating software and a printer driver and the like with a designation function of designating the decolorable toner to be used and making information of the designated decolorable toner contained in a print job. Then, the image forming apparatus 1 can form an image with a corresponding decolorable toner based on the designated decolorable toner information.

Besides, in the image forming apparatus 1, if images are formed only with a monochromic decolorable toner, then the images are preferably formed with the decolorable toner lowest in decoloring temperature. The use of the decolorable toner lowest in decoloring temperature lowers the temperature of the decoloring section of a decoloring apparatus and saves more energy.

(Decoloring Method)

The decoloring processing carried out for a recording paper (sheet) on which images are formed by the image forming apparatus 1 described herein with decolorable toners different in decoloring temperature. The decoloring apparatus (decoloring section) carrying out the decoloring processing may be an image forming apparatus using the fixing section 11 of the image forming apparatus 1 shown in FIG. 1 as a decoloring apparatus to achieve a decoloring function or a dedicated decoloring apparatus provided with a decoloring section for heating the processing target (paper) to be decolored which will be described later. In either case, it is preferable that setting temperature for the decoloring processing of the decoloring apparatus are stepwise according to decoloring temperatures of decolorable toners of different colors or an optional temperature can be set for the decoloring processing of the decoloring apparatus. Further, in this embodiment, a decoloring condition is changed through a temperature setting; however, the decoloring condition may also be set to be a pressure and a recording paper conveyance speed in combination with a temperature.

In the image forming apparatus 1, as the first image forming section 5a in which the decolorable toner A is stored is located at the upper stream side in the advancement direction of the intermediate transfer belt 6 with respect to the second image forming section 5b in which the decolorable toner B is stored, the decolorable toner A on the intermediate transfer belt 6 can be reversely transferred by the second image forming section 5b at the downstream side and mixed with the decolorable toner B.

In the case where characters are printed with the decolorable toner B mixed with the decolorable toner A, as the decoloring temperature of the decolorable toner B is higher than that of the decolorable toner A, no decoloring residual are left after the color of the decolorable toner B is decolored. As a result, the color of a printed content printed with the mixture of the decolorable toner A and the decolorable toner B can be completely decolored in a selectable manner, leaving no residual.

Then, the decolorable toner A, the decolorable toner B and the non-dicolorable toner C in the image forming apparatus 1 of this embodiment are described.

<Decolorable Toner>

In this embodiment, colors of the decolorable toner A and the decolorable toner B are decolored at different temperatures, and the color of the dicolorable toner B is decolored at a higher temperature. The decolorable toners contain an electron releasing coloring agent, an electron accepting developing agent, a decoloring temperature controlling agent and a binder resin.

The color-developing mechanism of the decolorable toner generates a color when the electron releasing coloring agent is bonded with the electron accepting developing agent and generates no color when the electron releasing coloring agent is separated from the electron accepting developing agent. With the use of a material which is called a decoloring temperature controlling agent the melting temperature and the solidification temperature of which is remarkably different, a color material is formed which decolores a color when heated to a temperature above the melting point of the decoloring temperature controlling agent and is kept in a decolored state at normal temperature when the solidification temperature of the decoloring temperature controlling agent is below normal temperature. The decolorable toners may further contain a release agent, a reactive polymer, a charge control agent, a coagulating agent, a surfactant, a PH adjuster and an external additive and the like.

The electron releasing coloring agent is a dye precursor compound for displaying the character or an image. Leuco dye is mainly used as the electron releasing coloring agent. The leuco dye, which is an electron-releasing compound capable of generating a color under the effect of a developing agent, may be, for example, diphenylmethane phthalides, phenylindolyl phthalides, indolylphthalides, diphenylmethaneazaphthalides, phenyl Indolylazaphthalides, fluorans, styryl quinolines and diazarhodaminelactones.

Specifically, the leuco dye is
3,3-Bis(p-dimethylaminophenyl)-6-dimethylaminophthalide,
3-(4-diethylaminophenyl)-3-(1-ethyl-2-methylindole-3-yl)phthalide,
3,3-Bis(1-n-butyl-2-methylindole-3-yl)phthalide,
3,3-Bis(2-ethoxy-4-diethylaminophenyl)-4-azaphthalide,
3-(2-ethoxy-4-diethylaminophenyl)-3-(1-ethyl-2-methylindole-3-yl)-4-azaphthalide,
3-[2-ethoxy-4-(N-ethylanilino)phenyl]-3-(1-ethyl-2-methylindole-3-yl)-4-azaphthalide,
3,6-diphenylaminofluoran,
3,6-dimethoxyfluoran,
3,6-n-dibutoxyfluoran,
2-methyl-6-(N-ethyl-N-p-tolylamino)fluoran,
2-N,N-dibenzylamino-6-diethylaminofluoran,
3-chloro-6-cyclohexylaminofluoran,
2-methyl-6-cyclohexylaminofluoran,
2-(2-chloroanilino)-6-n-dibutylaminofluoran,
2-(3-trifluoromethylanilino)-6-diethylaminofluoran,
2-(N-methylanilino)-6-(N-ethyl-N-p-tolylamino)fluoran,
1,3-dimethyl-6-diethylaminofluoran,
2-chloro-3-methyl-6-diethylaminofluoran,
2-anilino-3-methyl-6-diethylaminofluoran,
2-ailino-3-methyl-6-n-dibutylaminofluoran,
2-xylidino-3-methyl-6-diethylaminofluoran,
1,2-benz-6-diethylaminofluoran,
1,2-benz-6-(N-ethyl-N-isobutylamino)fluoran,
1,2-benz-6-(N-ethyl-N-isoamylamino)fluoran,
2-(3-methoxy-4-dodecoxystyryl)quinoline,
Spiro[5H-(1)benzopyrano(2,3-d)pyrimidine-5,1′(3′H)isobenzofuran]-3′one,2-(diethylamino)-8-(diethylamino)-4-methyl,
Spiro[5H-(1)benzopyrano(2,3-d)pyrimidine-5,1′(3′H)isobenzofuran]-3′one,2-(n-dibuthylamino)-8-(diethylamino)-4-methyl,
Spiro[5H-(1)benzopyrano(2,3-d)pyrimidine-5,1′(3′H)isobenzofuran]-3′-one,2-(n-dibuthylamino)-8-(diethylamino)-4-methyl;
Spiro[5H-(1)benzopyrano(2,3-d)pyrimidine-5,1′(3′H)isobenzofuran]-3′-one,2-(n-dibuthylamino)-8-(N-ethyl-N-i-amylamino)-4-methyl,
Spiro[5H-(1)benzopyrano(2,3-d)pyrimidine-5,1′(3′H)isobenzofuran]-3′one,2-(n-dibuthylamino)-8-(n-dibuthylamino)-4-phenyl,
3-(2-metoxy-4-diethylaminophenyl)-3-(1-ethyl-2-methylindole-3-yl)-4,5,6,7-tetrachlorophthalide,
3-(2-ethoxy-4-diethylaminophenyl)-3-(1-ethyl-2-methylindole-3-yl)-4,5,6,7-tetrachlorophthalide,
3-(2-ethoxy-4-diethylaminophenyl)-3-(1-pentyl-2-methylindole-3-yl)-4,5,6,7-tetrachlorophthalide and the like.

In addition, the electron releasing coloring agent may further be pyridines, quinazolines and bisquinazolines, two or more of which can be used together.

The electron accepting developing agent is an electron accepting compound for enabling the electron releasing coloring agent to generate a color and endowing the leuco dye with protons. The electron accepting developing agent is, for example, phenols, metal salts of phenol, metal salts of carvone acid, aromatic carboxylic acid and aliphatic acids having 2-5 carbons, benzophenones, sulfone acid, sulphonates, phosphoric acid, metal salts of phosphoric acid, alkyl acid phosphate, metal salts of acid phosphate, phosphorous acid, metal salts of phosphorous acid, monophenols, polyphenols, 1,2,3-triazole and derivatives thereof, or a component having a substitute group of an alkyl, an aryl, an acyl, an alkoxycarbonyl, a carboxyl and esters thereof or an amide group or a halogen group, and a bis- or tris-phenol, phenolaldehyde condensation resin and metal salts thereof.

Specifically, the electron accepting developing agent is
phenol,
o-cresol,
t-butylcatechol,
Nonylphenol,
n-octylphenol,
n-dodecylphenol,
n-stearylphenol,
p-chlorophenol,
p-bromophenol,
o-phenylphenol,
p-hydroxybenzoic acid n-butyl,
p-hydroxybenzoic acid n-octyl,
p-hydroxybenzoic acid benzyl,

dihydroxybenzoic acid or esters thereof, such as
2,3-dihydroxybenzoic acid,
3,5-dihydroxybenzoic acid,
Resorcinol,
gallic acid,
dodecyl gallate,
ethyl gallate,
butyl gallate,
propyl gallate,
2,2-Bis(4-hydroxyphenyl)propane,
4,4-dihydroxyphenylsulfone,
1,1-Bis(4-hydroxyphenyl)ethane,
2,2-Bis(4-hydroxy-3-methyl phenyl)propane,
Bis(4-hydroxyphenyl)sulfide,
1-phenyl-1,1′-Bis(4-hydroxyphenyl)ethane,
1,1-Bis(4-hydroxyphenyl)-3-methylbutane,
1,1-Bis(4-hydroxyphenyl)-2-methyl propane
1,1-Bis(4-hydroxyphenyl)-n-hexane,
1,1-Bis(4-hydroxyphenyl)-n-heptane,
1,1-Bis(4-hydroxyphenyl)-n-octane,
1,1-Bis(4-hydroxyphenyl)-n-nonane,
1,1-Bis(4-hydroxyphenyl)-n-decane,
1,1-Bis(4-hydroxyphenyl)-n-dodecane,
2,2-Bis(4-hydroxyphenyl)butane,
2,2-Bis(4-hydroxyphenyl)ethylpropionate,
2,2-Bis(4-hydroxyphenyl)-4-methylpentane,
2,2-Bis(4-hydroxyphenyl)hexafluoropropane,
2,2-Bis(4-hydroxyphenyl)-n-heptane,
2,2-Bis(4-hydroxyphenyl)-n-nonane,
2,4-dihydroxyacetophenone,
2,5-dihydroxyacetophenone,
2,6-dihydroxyacetophenone,
3,5-dihydroxyacetophenone,
2,3,4-trihydroxyacetophenone,
2,4-dihydroxybenzophenon;
4,4′-dihydroxybenzophenon;
2,3,4-trihydroxybenzophenone,
2,4,4′-trihydroxybenzophenone,
2,2′,4,4′-tetrahydroxybenzophenone
2,3,4,4′-tetrahydroxybenzophenone,
2,4′-biphenol,
4,4′-biphenol,
4-[(4-hydroxyphenyl)methyl]-1,2,3-benzenetriol,
4-[(3,5-dimethyl-4-hydroxyphenyl)methyl]-1,2,3-benzenetriol,
4,6-Bis[(3,5-dimethyl-4-hydroxyphenyl)methyl]-1,2,3-benzenetriol,
4,4′-[1,4-phenylenebis(1-methylethylidene)Bis(benzene-1,2,3-triol)],
4,4′-[1,4-phenylenebis(1-methylethylidene)Bis(1,2-benzenediols)],
4,4′,4″-ethylidenetrisphenol,
4,4′-(1-methylethylidene)Bis phenol,

Methylenetris-p-cresol and the like, two or more of which may be used together.

The decoloring temperature controlling agent controls a decoloring temperature. The decoloring temperature controlling agent may be any compound that can hinder the color generation reaction thermally caused by the leuco dye serving as a coloring agent and a developing agent in a three-component system consisting of the coloring agent (color generating compound), the developing agent and the decoloring temperature controlling agent.

The decoloring temperature of the decolorable toner can be controlled by changing the type of the decoloring temperature controlling agent contained in the decolorable toner. The image formed on paper with the decolorable toner needs to be heated to above the decoloring temperature of the decolorable toner to be decolored. Thus, to decolor stepwise by changing a decoloring temperature according to a different color, for example, decolor a yellow image but keeping a magenta toner mage, decoloring temperatures of toners of different colors are set differentially while the temperature of the decoloring apparatus is controllable. Specifically and preferably, the difference between the decoloring temperatures is above 5 degrees centigrade, and more preferably, above 15 degrees centigrade.

Especially, the color generating and decoloring mechanisms disclosed in Japanese Unexamined Patent Application Publication No. Shou 60-264285, Japanese Unexamined Patent Application Publication No. 2005-1369 and Japanese Unexamined Patent Application Publication No. 2008-280523 making use of the temperature hysteresis of the known decoloring temperature controlling agents are excellent in instantaneous decolorization property, thus, the use of a decoloring temperature controlling agent is preferred. The color of the three-component color generating mixture is decolored after the mixture is heated to above a specific decoloring temperature Th. Further, the decolored mixture remains decoloring state even if cooled to a temperature (room temperature) lower than the temperature Th. When cooled further to be below a specific color recovery temperature Tc, the coloring reaction caused by the leuco dye and the developing agent may occur again to return to a color generation state, thus, reversible coloring reaction and the decoloring reaction may both occur. Specifically and preferably, the decoloring temperature controlling agent used herein meets the following relationship: Th>Tr(room temperature)>Tc.

The decoloring temperature controlling agent causing the temperature hysteresis may be alcohols, esters, ketones, ethers and acid amides, and preferably, esters. Specifically, the ester is a carboxylic ester containing a replaceable aromatic ring, esters of a carboxylic acid containing an irreplaceable aromatic ring and aliphatic alcohol, a carboxylic ester molecularly containing a cyclohexyl group, esters of fatty acid and irreplaceable aromatic alcohol, esters of fatty acid and branched aliphatic alcohol, esters of dicarboxylic acid and aromatic alcohol or branched aliphatic alcohol, cinnamate dibenzyl, stearin acid heptyl, didecyl adipate, adipic acid dilauryl, adipic acid dimyristyl, adipic acid dicetyl, adipic acid distearyl, trilaurin, trimyristin, tristearin, dimyristin, distearin and the like, two or more of which may be used together.

The binder resin is melted in a fixing processing to be fixed on paper to serve as the coloring agent or developing agent of a color material. Preferably, the binder resin is a polyester fiber resin prepared by successively conducting an esterification reaction and a condensation polymerization for a dicarboxylic acid component and a diol component. From the point of view of low temperature fixation, the use of a styrene resin the glass transition temperature of which is usually higher than that of polyester fiber is unfavorable. The acid component may be dicarboxylic acids, such as terephthalic acid, phthalic acid, isophthalic acid and the like; and carboxylic acids, such as fumaric acid, maleic acid, succinic acid, adipic acid, sebacic acid, glutaric acid, pimelic acid, oxalic acid, malonic acid, citraconic acid and itaconic acid and the like.

The alcohol component (diol component) may be aliphatic diols including ethylene glycol, propylene glycol, 1,4-butanediol, 1,3-butanediol, 1,5-pentanediol, 1,6-hexanediol, neopentyl glycol, trimethylene glycol, trimethylolpropane and pentaerythritol, alicyclic diols including 1,4-cyclohexanediol and 1,4-cyclohexanedimethyl, ethylene oxides of bisphenol A and the like or propylene oxide additives.

In the binder resin, the polyester component may be constructed as a cross-bridging structure by using polyvalent carboxylic acid or polyvalent alcohol component having a valence of greater than 3 such as 1,2,4-benzenetricarboxylic acid(trimellitic acid) or glycerin, two or more of which may be fixed and used together.

Polyester fiber resin serving as the binder resin may be non-crystalline polyester resin or crystalline polyester resin. Preferably, the glass transition temperature of the polyester fiber resin is within a range of equal to or higher than 45 degrees centigrade but lower than 70 degrees centigrade, more preferably, equal to or higher than 50 degrees centigrade but lower than 65 degrees centigrade. If the glass transition temperature is below 35 degrees centigrade, the heat-resistant preservability of the toner is deteriorated and the resin is glossy when decolored, thus, a glass transition temperature of below 35 degrees centigrade is unfavorable. If the glass transition temperature is above 70 degrees centigrade, the low temperature fixation property of the toner is deteriorated and the decolorizing of the toner is degraded when the toner is heated, thus, a glass transition temperature of above 70 degrees centigrade is unfavorable.

The release agent improves the release properties of the toner from a fixing member when the toner is fixed on paper with heat or pressure. The release agent may be aliphatic hydrocarbon based waxes including low molecular weight polyethylene, low molecular weight polypropylene, polyolefin copolymer, polyolefin wax, paraffin wax and Fischer-Tropsch wax and modifications thereof, vegetable waxes including Candelilla wax, Carnauba wax, Japan wax, Jojoba wax and Rice wax, animal waxes including bees wax, lanolin and whale wax, mineral waxes including montan wax, ozokerite wax and ceresin wax, fatty acid amides including linoleic acid amide, oleic acid amide and lauric acid amide, functional synthetic wax and silicon wax and the like.

The reactive polymer is, for example, a polymer having a bridging capability for the binder resin. The reactive polymer may be a reactive polymer having an oxazoline group. As the decolorable toner used in this embodiment is aqueous, the reactive polymer is preferably water-soluble. As a preferred product available on the market, the reactive polymer is, for example, ‘EPOCROS WS-500’, ‘EPOCROS WS-700’ produced by Nippon Shokubai Co., Ltd.

Further, the reactive polymer may also be compounds having an epoxy group, for example, Denacol EX313, 314, 421, 512 and 521 produced by Nagase ChemteX Corporation. The compounds having an epoxy group can be used separately when the binder resin is a resin having a carboxyl (oxidizable polyester or polystyrene resin). A material having an amino or hydroxyl group may be added in the reactive polymer.

Color material particles can be fully imported into the toner with a bridging agent using such reactive polymers, thus, the concentration of the printed image is improved, and the image defects such as fuzziness are weakened.

The charge control agent controls the quantity of the charges charged through frictional electrification. The charge control agent may be a metal-containing azo compound, wherein the metal element is preferably the complex and the complex salt of Fe, Cobalt and Chromium or the mixture thereof. Further, the charge control agent may also be a metal-containing salicylic acid derivative compound. Preferably, the metal element contained in the metal-containing salicylic acid derivative compound is the complex and the complex salt of Zirconium, zinc, chrome and Boron or the mixture thereof.

In addition to monovalent metal salts including sodium chloride, polyvalent metal salts including magnesium sulfate and aluminum sulfate and non-metallic salts including ammonium chloride and ammonium sulfate, the coagulating agent, to which no particular limitation is given, may also be a strong cationic coagulating agent such as hydrochloric acid, nitric acid and the other acids, polyamine and DADMAC polymer.

The surfactant, to which no particular limitation is given, may be an anionic surfactant such as sulfate based, sulfonate based, phosphoric esters and fatty acid salts, a cationic surfactant such as amine salt and quaternary ammonium salts, an ampholytic surfactant such as betaines, a nonionic surfactant such as polyethylene glycols, alkylphenol and ethylene oxide additives and polyvalent alcohols or a high molecular surfactant such as polycarboxylic acid. Usually, the surfactant is added when the toner is prepared to improve the stability of aggregated particles and endow the toner with dispersion stability; however, a surfactant having a reverse polarity may also be used as a coagulating agent.

The PH adjuster controls the PH value of the toner. The PH adjuster, to which no particular limitation is given, may properly use a basic compound such as sodium hydroxide, potassium hydroxide and amines as alkali and an acid compound such as hydrochloric acid, nitric acid and sulfuric acid as acid.

In addition, in this embodiment, 0.01-20% by weight of inorganic micro-particles may be mixed in toner particles as an external additive to adjust the fluidity or the charging proper of the toner particles. The inorganic micro-particles may be silicon dioxide, titanium dioxide, alumina, Strontium titanate, Tin oxide or the mixture of two or more of them. For the sake of environmental stability, the inorganic micro-particles are preferably subjected to a surface processing using a hydrophobic agent. In addition to such an inorganic oxide, resin micro-particles the diameter of which is below 1 μm may also be added as an external additive to improve cleanness.

To be fixed, fixing temperatures of the decolorable toner A and the decolorable toner B are generally higher than the glass transition temperature Tg of the binder resin and are at least approximate to the softening temperature Tm of the binder resin. Further, to prevent a decoloring reaction during a fixation process, the fixing temperatures of the toners are required to be below the decoloring temperature Th.

Further, the electron releasing coloring agent, the electron accepting developing agent and the decoloring temperature controlling agent are preferably microencapsulated into a color material. The microencapsulation resists external influences to achieve a more accurate control on the generation and the decolorizing of a color.

(Preparation Method of Toners)

The preparation method of the decolorable toners used herein is described below. Preferably, the decolorable toners used herein are prepared by preparing micro-particles components of the decolorable toners using the called chemical preparation method first and then adjusting the diameter of the micro-particles to particle diameters needed by the toners using a coagulation method. On the other hand, in the called pulverizing-kneading method, as the kneading temperature is usually higher than the decoloring temperature of the color material, colors are decolored at this point of time.

In the chemical preparation method, a fusion process is conducted after the toner particles are coagulated so as to smooth the surface of the toners and round the toners. The fusion process is conducted at a fusion temperature higher than the glass transition temperature Tg of the resin. Consequentially, the color of the color material is decolored in the fusion process when the decoloring temperature of the color material is lower than the fusion temperature. Thus, the decoloring temperature of the color material is preferably higher than the fusion temperature.

The series of flow of the preparation of the decolorable toners is exemplified below. First, the color material consisting of the coloring agent, the developing agent and the decoloring temperature controlling agent is heated and melted. Then, the color material is microencapsulated with polyurethane resin using a coacervation method. The microencapsulated color material, a binder resin dispersion obtained by dispersing the binder resin and a release agent dispersion obtained by dispersing the release agent are coagulated with a coagulation agent (e.g. Al₂ (SO₄)₃) and then melted. The obtained material is cleaned and dried to obtain the toners. Besides, decolorable toners of different colors are prepared using different kinds of decoloring temperature controlling agents so that different colors are decolored at different decoloring temperatures.

Further, the color material is microencapsulated using a wall formation method using isocyanate polyol, a wall formation method using urea-formaldehyde or urea formaldehyde-resorcinol or a wall formation method using melamine-formaldehyde resin or hydroxyl propylcellulose. The encapsulation method, which is not limited to an interfacial polymerization method or a coacervation method, may also be a method based on the polymer precipitation, an in-situ method based on the polymerization of monomers, an electrolytic dispersion cooling method and a spray drying method and the like.

<Non-Dicolorable Toner>

The non-dicolorable or color inerasable toner C used herein, to which no particular limitation is given, may be known non-dicolorable toner particles containing a coloring agent and a binder resin and a toner the surface of which s added with an additive, if needed. The coloring agent is, for example, carbon black, known pigments including condensed polycyclic-based pigment, azo pigment, phthalocyanine pigment and inorganic pigment and dyes. The binder resin may be, for example, polyester resin or styrene-acrylic resin. Further, wax may be added in the toner particles as a fixation additive and a charge control agent (CCA) may be added in the toner particles. If the fixation temperatures and the decoloring temperatures of the decolorable toners A and B are taken into consideration, then a toner the fixation temperature of which is at the same level with those of the decolorable toners A and B is preferably used.

Further, in the use of a two-component developing agent, a decolorable toner and a non-dicolorable toner are mixed with a carrier.

Above is description of the structure of the image forming apparatus 1 described herein and structures of the toners used in the image forming apparatus 1. Further, in the foregoing embodiment, toners are described as a decolorable recording material and a non-dicolorable recording material, however, ink liquid, colloidal ink or an ink ribbon may also be used matching with the form of an image forming apparatus.

In this embodiment, a temperature setting is set for the fixation of the fixing section 11 of the image forming apparatus 1, and a dedicated decoloring apparatus may be used to conduct a decoloring processing.

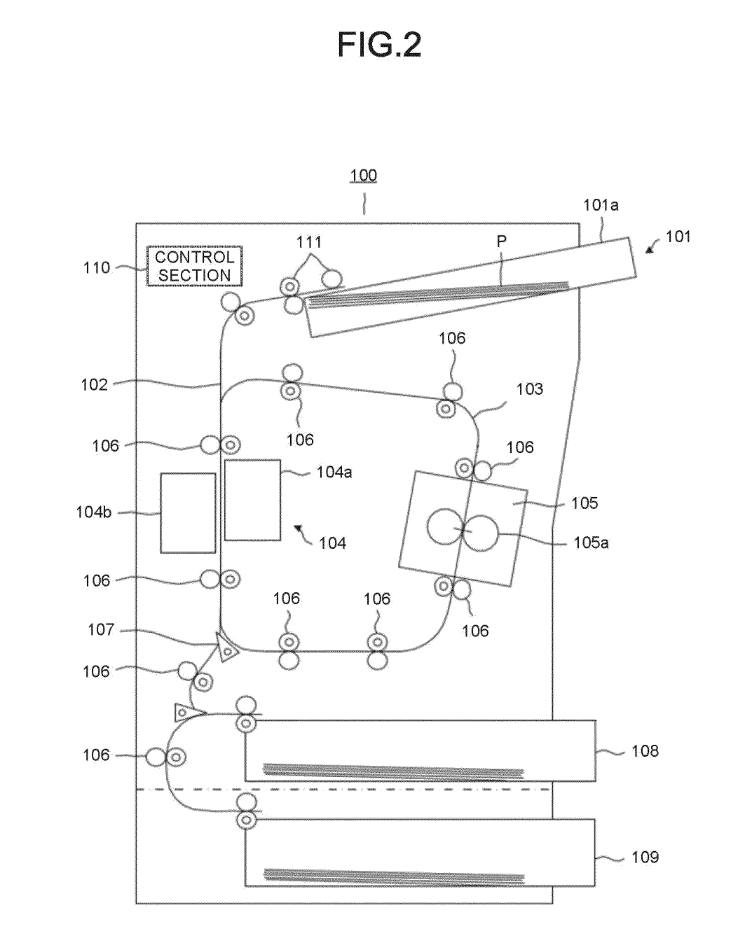

FIG. 2 shows an example of the decoloring apparatus according to the embodiment. As shown in FIG. 2, the decoloring apparatus 100 is capable of decoloring the color of the image formed on paper (recording medium) by the image forming apparatus 1 to reuse the paper. The decoloring apparatus 100 comprises a paper feed section 101, a first conveyance path 102, a second conveyance path 103, a first reading section 104a, a second reading section 104b, a decoloring section 105, conveyance rollers 106, a path changing (switching) section 107, a first paper discharging section 108 and a second paper discharging section 109. The decoloring apparatus 100 further comprises a control section 110 for controlling the whole processing operations of the decoloring apparatus 100.

The paper feed section 101 feeds paper into the decoloring apparatus 100 to decolor the color of the image formed on the paper P to reuse the paper. The paper feed section 101 is equipped with a paper feed tray 101a and a pickup roller 111. The paper feed tray 101a accommodates reusable paper. The pickup roller 111 picks up paper P, piece by piece, from the paper feed tray 101a and conveys the paper to the first conveyance path 102.

The first conveyance path 102 and the second conveyance path 103 comprise a plurality of conveyance rollers 106, each of which consists of a drive roller and a driven roller. The first conveyance path 102 comprises a pair of first reading section 104a and second reading section 104b. The first reading section 104a and the second reading section 104b are provided with a two-dimensional CCD scanner. The first reading section 104a reads one side of the paper conveyed from the paper feed section 101, and the second reading section 104b reads the other side of the paper opposite to the side read by the first reading section 104a.

Images read by the first reading section 104a and the second reading section 104b are stored in a RAM (Random Access Memory) in the control section 110. The images read by the first reading section 104a and the second reading section 104b may also be stored in a ROM (Read Only Memory), a HDD (Hard Disk Drive) or a memory, but is not limited to be stored in the RAM. Further, not limited to be stored in the RAM in the control section 110, the images read by the first reading section 104a and the second reading section 104b may also be stored in a ROM of a PC or a server connected with the decoloring apparatus 100 via a network. In the case where the decoloring apparatus 100 has a login and a logout functions to authenticate individual users, the image data stored in the RAM of the decoloring apparatus 100 may be sent to the ROM of the PC or sever connected with the decoloring apparatus 100 via a network and then stored in the ROM of the PC when the user logs out the decoloring apparatus 100.

Further, the first reading section 104a and the second reading section 104b read the surface of paper to determine whether or not the paper can be used and whether or not the color of the content printed on the paper is decolored.

The first reading section 104a and the second reading section 104b carry out the reading operation twice. The images read by the first reading section 104a and the second reading section 104b in the first time of reading are converted into digital data and stored in a storage section. The first reading section 104a and the second reading section 104b determines whether or not the decolored paper is reusable in the second time of reading. Besides, in the first time of reading, the image may be stored, and whether or not the paper cannot be used due to corrugation, staple, fracture or a non-dicolorable memo is determined. The settings described above can be selected and set in advance.

The first conveyance path 102 connects the paper feed section 101 with the first paper discharging section 108 or the second paper discharging section 109. The second conveyance path 103 is branched off from a branch point at the downstream side of the first reading section 104a and the second reading section 104b of the first conveyance path 102 and combined with the first conveyance path 102 at the upstream side of the first reading section 104a and the second reading section 104b of the first conveyance path 102. A path changing section 107 is arranged at the branch point.

A decoloring section 105 is arranged in the second conveyance path 103. The decoloring section 105 comprises a roller pair 105a which is heated by a heater or the like. The paper P is applied with a temperature higher than a given temperature or heat with the heated roller pair 105a to heat the image formed on the paper P with a decolorable recording material to decolor the color of the color material. By decoloring the color of the image using the roller pair 105a, the decoloring section 105 decolors the color of the images formed on two sides of the paper P.

The paper P subjected to various processing is discharged to the first paper discharging section 108 or the second paper discharging section 109. Alternatively, the paper P may be discharged to either of the first paper discharging section 108 and the second paper discharging section 109 according to the selection of the user.

The decoloring apparatus 100 may stepwise set the setting temperature for the decoloring processing carried out by the decoloring section 105 according to decoloring temperatures of decolorable toners of different colors or set the decoloring temperature of the decoloring section 105 to any temperature.

### Embodiment

A specific embodiment is described below in detail. First, the preparation of the decolorable toners A and B and the color non-dicolorable toner C is exemplified. A yellow color material Y is used for the decolorable toner A and a magenta color material M is used for the decolorable toner B.

(Preparation of Yellow Color Material Y)

1 part by weight of 4-[2,6-bis(2-(Ethoxyphenyl))-4-pyridyl]-N,N-dimethylbenzeneamine serving as the leuco dye, that is, the coloring agent of the color material Y, 5.0 parts by weight of 2,2bis(4′hydroxyphenyl) (hexafluoropropane) serving as a developing agent and 50 parts by weight of diester of pimelic acid and 2-(4-benzyloxyphenylethanol) serving as a decoloring temperature controlling agent are uniformly heated and melted, a solution obtained by mixing 20 parts by weight of polyvalent isocyanate prepolymer and 40 parts by weight of ethyl acetate serving as a capsulation agent is emulsified and dispersed in 300 parts by weight of 8% polyvinyl alcohol solution, the obtained dispersion is continuously stirred for about 1 hour at 90 degrees centigrade and then added with 2.5 parts by weight of water-soluble aliphatic modified amine serving as a reactant, then the modified solution is continuously stirred for 6 hours to obtain capsule particles. The volume average particle diameter of the obtained dispersion is 3 μm. The color of the obtained dispersion is yellow. The decoloring temperature of the obtained dispersion is 74.5 degrees centigrade, and the concentration of the effective solid content of the obtained dispersion is 70%.

(Preparation of Magenta Color Material M)

The color material M is prepared in the way the color material Y is prepared except that the leuco dye serving as the coloring agent of the color material M is changed to 2-(dibutylamino)-8-(dipentyl amino)-4-methy-Spiro[5H-[1]benzopyran[2,3-g]Pyrimidine-5,1′(3′H)-Isobenzofuran]-3-one, the developing agent is changed to 2,2Bis(4′hydroxyphenyl)(Hexafluoropropane) and the decoloring temperature controlling agent is changed to diester of suberic acid and 2-(4-benzyloxyphenyl)ethanol. The color of the obtained particles is magenta. The decoloring temperature of the obtained dispersion is 90.5 degrees centigrade, and the concentration of the effective solid content of the obtained dispersion is 70%.

(Preparation of Non-Crystalline Polyester Resin A)

53.1 parts by weight of polyoxypropylene (2.2)-2,2-Bis(4-hydroxyphenyl)propane, 21.1 parts by weight of polyoxyethylene (2.0)-2,2-Bis(4-hydroxyphenyl) propane, 22.6 parts by weight of fumaric acid, 3.2 parts by weight of adipic acid, 0.1 part by weight of tert-butyl catechol and 0.5 part by weight of tin octylate are added and heated to 210 degrees centigrade in a nitrogen atmosphere and reacted at this temperature, then, the obtained material is reduced in pressure and polymerized at 8.3 Kpa until a desired softening point is reached, then an amorphous polyester resin A used for the binder resin is obtained.

(Preparation of Release Agent Dispersion A)

480 g deionized water and 4.3 g dipotassium alkenylsuccinate solution (product name: Ramuteru ASK, produced by Kao Corporation, effective concentration: 28 wt %) are added in a 1-litre beaker to disperse 120 g carnauba wax. The dispersion solution is processed for 30 min using an ultrasonic homogenizer US-600T (produced by NISSEI Corporation) while being kept at 90-95 degrees centigrade to be dispersed. The dispersion solution is cooled and added with deionized water to adjust the concentration of the solid content to be 20 wt %, and then a release agent dispersion is obtained. The volume average diameter of the obtained release agent dispersion is 0.42 μm, and the concentration the effective solid content is 40%.

(Preparation of Resin Dispersion A)

600 g non-crystalline polyester resin A, 40 g anionic surfactant ‘NEOPELEX G-15 (produced by Kao Corporation)’ sodium dodecylbenzenesulfonate (solid content: 15 wt %), 6 g nonionic surfactant ‘EMULGEN 430 (produced by Kao Corporation)’ polyoxyethylene (26 mol) oleyl ether and 218 g potassium hydroxide solution (5 wt %) are added in a 5-litre stainless kettle and stirred at a speed of 200 r/min, dispersed at 25 degrees centigrade, and then heated to 90 degrees centigrade. The heated mixture is stably stirred for 2 hours at 90 degrees centigrade. Sequentially, 1076 g deionized water is dropped at a speed of 6 g/min to obtain an emulsion. The emulsion is cooled and screened with a screen mesh to obtain a binder resin dispersion A for the toner. The volume average diameter and the solid content of the obtained binder resin dispersion A are 0.16 μm and 32 wt %.

<Example of Preparation of Decolorable Toner A>

28 g color material Y is added with 290 g deionized water to be fully dispersed. Thus, the mixture consisting of 45 g release agent dispersion A, 200 g resin dispersion A and 200 g deionized water is quantitatively fed at 45 degrees centigrade within 7 hours. 100 g ammonium sulfate solution (concentration: 30%) is added as a coagulation agent during this process. Then, 2.5 g EPOCROS WS-700 serving as a crosslinking agent produced by Nippon Shokubai Co., Ltd and a dispersing agent added with 2.7 g EMAL E-27C produced by Kao Corporation and 80 g deionized water are fed, then, the mixture is heated to 65 degrees centigrade and then placed still for 2 hours to melt the toner. The volume average diameter of the obtained toner is 10.5 μm. Sequentially, the toner is cleaned with pure water and then dried until the content of water is below 1 wt %. Then, the obtained toner with a concentration 3.0 wt % and the NKT90 (TiO₂) with a concentration 0.3 wt % are externally added to 100 wt % of NAX50 (SiO2) toner produced by Nippon Aerosil Co., Ltd.

<Example of Preparation of Decolorable Toner B>

The decolorable toner B is prepared in the way the decolorable toner A is prepared except that the color material Y of the decolorable toner A is replaced by color material M.

<Example of Preparation of Color Non-Dicolorable Toner C>

The color non-dicolorable toner C is prepared in the way the decolorable toner A is prepared except that the color material Y of the decolorable toner A is replaced by carbon black.

(Example of Image Forming Processing)

FIG. 1 shows an example of fixation temperatures and decoloring temperatures of toners A, B and C prepared in the way described above.

TABLE 1
fixation temperature and color erasing temperature of toner

| | Fixation | Color erasing |
|---|---|---|
| | temperature | temperature |
| | (° C.) | (° C.) |
| Color erasable toner A | 60 | 74.5 |
| Color erasable toner B | 60 | 90.5 |
| Color inerasable toner C | 60 | — |

Fixation temperatures of the decolorable toner A (Y), the decolorable toner B (M) and the color non-dicolorable toner C (K) are all 60 degrees centigrade, as shown in Table 1. Further, the decoloring temperature of the decolorable toner A is 74.5 degrees centigrade, and that of the decolorable toner B is 90.5 degrees centigrade.

In the image forming apparatus shown in FIG. 1, it is set that a developing agent using the decolorable toner A is stored in the first image forming section 5a, a developing agent using the decolorable toner B is stored in the second image forming section 5b and a developing agent using the color non-dicolorable toner C is stored in the third image forming section 5c. The fixation temperature of the fixing section 11 shown in FIG. 1 can be changed. Thus, the image forming apparatus 1 is an apparatus which can also be used as a color decolorizer (decoloring section) as long as the temperature of the fixing section 11 is set to be higher than the decoloring temperature of a decolorable toner. It is set that a printing job is carried out using the decolorable toners A and B and the non-dicolorable toner C. By setting the temperature of a fixer to be 60 degrees centigrade, the toner can be fixed at a relative low temperature such as 60 degrees centigrade to form an image. Paper may be PPC paper (P-50s) produced by Toshiba Corporation.

Further, a decoloring processing is carried out using a decoloring function. First, images formed with the decolorable toners A and B are decolored when the printed content is decolored by setting a setting temperature (decoloring temperature) for a decoloring processing to be 100 degrees centigrade. Next, when the decoloring temperature is set to be 85 degrees centigrade to decolor the printed content, the image formed with the decolorable toner B is retained in a color generating state while the image formed with the decolorable toner A is decolored.

According to the foregoing embodiment, by forming images with the decolorable toners A and B different in decoloring temperature, the image of a specific color is decolored according to a setting temperature for decoloring processing while images of other specific colors are retained in a color generating state. Then, as the decolorable toner A reversely transferred on the photoconductive drum (image carrier) 51b of the image forming section 5b at the downstream side in the advancement direction of the intermediate transfer belt (image receiving member) 6 is lower in decoloring temperature than the decolorable toner B, the color of the decolorable toner A mixed with the decolorable toner B is decolored through the decoloring processing carried out for the image formed with the decolorable toner B. That is, in the embodiment, no residual printed content is left from a decoloring processing even if toners different in decoloring temperature are mixed through a reverse transfer.

Thus, the image forming apparatus disclosed herein is capable of synchronously printing a content desired to be decolored repeatedly, a content seldom decolored such as a frame in a given format and a content desired not to be decolored and decoloring contents selectively. In addition, in an image forming apparatus of a cleaner-less type, no printed content is left from a decoloring processing even if toners different in decoloring temperature are mixed through a reverse transfer.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a first image forming section configured to form, an image on an image receiving member with a first decolorable recording material, the color of which can be thermally decolored; and
a second image forming section provided at the downstream of the first image forming section along an advancement direction of the image receiving member and configured to form an image on the image receiving member with a second decolorable recording material, decoloring temperature of decolorable recording material being higher than the decoloring temperature of the first decolorable recording material.

2. The image forming apparatus according to claim 1, wherein the first image forming section and the second image forming section are provided with an image carrier and a developing device for developing the electrostatic latent image on the image carrier.

3. The image forming apparatus according to claim 2, wherein the image forming apparatus is of a cleaner-less type which collects, with the developing device, the decolorable recording material left on the image carrier after an image is formed on the image receiving member.

4. The image forming apparatus according to claim 1, wherein the first decolorable recording material is different in color from the second decolorable recording material.

5. The image forming apparatus according to claim 1, further comprising: a third image forming section configured to form an image on the image receiving member with a non-dicolorable recording material.

6. The image forming apparatus according to claim 1, wherein the first decolorable recording material and the second decolorable recording material contain a color material composed of an electron releasing coloring agent, an electron accepting developing agent and a decoloring temperature controlling agent.

7. The image forming apparatus according to claim 6, wherein the color material is microencapsulated.

8. The image forming apparatus according to claim 1, wherein colors of images formed on the image receiving member by the first and second image forming sections can be selectively decolored.

9. The image forming apparatus according to claim 8, wherein the image receiving member is sheet.

10. An image forming apparatus, comprising:
a plurality of image forming sections provided with an image carrier and a developing device for developing the electrostatic latent image formed on the image carrier with a decolorable toner with which color can be decolored by heating, wherein the decolorable toners accommodated in the developing device are different in decoloring temperature; and
a transfer section configured to transfer the toner images formed in the plurality of image forming sections onto a image receiving member,
wherein the plurality of image forming sections are arranged along the advancement direction of the image receiving member according to decoloring temperatures, from the highest to the lowest, of the accommodated decolorable toners.
